(19) United States
(12) Patent Application Publication
(10) Pub. No.: US 2021/0140480 A1
(43) Pub. Date: May 13, 2021

(54) WHEEL BEARING OUTER RING

(71) Applicant: SKF Aerospace France S.A.S, Montigny-le-Bretonneux (FR)

(72) Inventors: Alexandre Poligné, Arthemonay (FR); Rémi Sarlin, Allex (FR)

(21) Appl. No.: 17/019,423

(22) Filed: Sep. 14, 2020

(30) Foreign Application Priority Data
Nov. 7, 2019 (DE) 102019217236.9

(51) Int. Cl. F16C 33/58; F16C 19/18

(52) U.S. Cl. CPC F16C 33/585; F16C 2326/02; F16C 19/181

(57) ABSTRACT

A wheel bearing outer ring having at least a first ring made of a composite material and a metal ring. The metal ring provides at least two raceways that are configured for rolling elements to roll on.

### CROSS-REFERENCE TO RELATED APPLICATIONS

This application claims priority to German Patent Application no. 102019217236.9, filed Nov. 7, 2019, the contents of which is fully incorporated herein by reference.

### TECHNICAL FIELD OF THE INVENTION

The invention relates to a wheel bearing outer ring having at least a first ring made of a composite material and a metal ring. The invention particularly relates to a wheel bearing outer ring having at least a first ring made of a composite material and a metal ring with at least two raceways that are configured for rolling elements to roll on.

### BACKGROUND OF THE INVENTION

From the patent application WO 2009/064729 A2 a wheel bearing with a wheel bearing outer ring is known which comprises a main body made from composite material and raceway liners made from bearing quality steel.

### SUMMARY OF THE INVENTION

The task of the invention is in particular to provide a generic wheel bearing outer ring with an efficient construction style.

The invention is based on a wheel bearing outer ring comprising at least a first ring made of a composite material and a metal ring.

It is proposed that the metal ring comprises at least two raceways which are configured for rolling elements to roll off. According to the invention an efficient construction style can be achieved. In particular a lightweight, very stiff and compact construction design can be attained.

Furthermore, a wheel bearing outer ring comprising at least a first ring made of a composite material and a metal ring is suggested, wherein the metal ring comprises at least one raceway for rolling elements to roll off and at least one fastening element configured to fix the wheel bearing outer ring to a knuckle. According to the invention an efficient and in particular a cost-effective construction style can be achieved.

Preferably the wheel bearing outer ring comprises at least one stiffening element which increases the local stiffness of the fastening element. Through this an increased overall stiffness of the wheel bearing outer ring is reached.

Besides that a wheel bearing outer ring comprising at least a first ring made of a composite material and a metal ring is proposed, wherein the first ring is positioned at an axial end of the wheel bearing outer ring and provides a surface for attaching a gasket configured for sealing a space between the wheel bearing outer ring and a wheel bearing inner ring in a fully assembled condition. According to the invention an efficient construction style can be achieved. In particular it can be attained that the gasket does not have to be fixed to a region of a steel part, which is replaced by a lighter composite part, which contributes to a low mass of the wheel bearing outer ring. An idea of the last mentioned aspect is to insist on an increase of the global size of the metal ring diameter at the axial end but to limit the increase of weight by replacing the inner side of the part with a lighter material.

Furthermore, a wheel bearing outer ring comprising at least a first ring made of a composite material and a metal ring, is suggested, wherein the metal ring has at least one through hole extending from a radial inner surface of the metal ring to a radial outer surface of the metal ring. According to the invention an efficient construction style can be achieved. In particular a lightweight construction style in a region of the wheel bearing outer ring is achieved, in which low mechanical demands will occur.

Moreover, a wheel bearing outer ring according to any one of the preceding claims is suggested, wherein the metal ring comprises at a range, which is positioned axially in the middle, at least one groove at its radially outer surface. Through this a further contribution to a lightweight construction style in a region of the wheel bearing outer ring is attained, in which low mechanical demands will occur. Preferably the wheel bearing outer ring comprises at least a second ring made of a composite material which is at least partially positioned within the groove. Thereby the wheel bearing outer ring can comprise at range, which is positioned axially in the middle, the same diameter as in adjacent regions.

Preferably the metal ring has an outer diameter of more than 134 mm at an axial position at which the first ring is located. Through this an enlarged diameter can be achieved which resides in stiffer construction.

Moreover, a wheel bearing with at least one such wheel bearing outer ring is suggested.

Furthermore, a car, in particular a hyper car, with at least one such wheel bearing is proposed.

### BRIEF DESCRIPTION OF THE SEVERAL VIEWS OF THE INVENTION

Further advantages result from the following drawing description. The drawing shows an example of the invention. The drawings, the description and the claims contain numerous features in combination. The person skilled in the art will also consider the features individually and summarize them to meaningful further combinations.

FIG. 1 shows an axial section through a wheel bearing outer ring according to the invention,

FIG. 2 shows a perspective view of the wheel bearing outer ring, and

FIG. 3 shows a front view of the wheel bearing outer ring.

### DETAILED DESCRIPTION OF THE INVENTION

FIG. 1 shows an axial section through a wheel bearing outer ring according to the invention. The wheel bearing outer ring comprises a metal ring 14 and the first ring 12 which consists of a composite material. The metal ring is a one-piece element and comprises two raceways 16, 18 which are configured for rolling elements, in this embodiment balls, to roll off. The metal ring 14 extends over the whole axial length of the wheel bearing outer ring. Furthermore, the metal ring 14 comprises a fastening element 20 and further fastening elements each of which is configured to fix the wheel bearing outer ring to a knuckle. The fastening elements are located at the same axial position and only distant from each other in the circumferential direction of the wheel bearing outer ring. For fixation of the fastening elements to the knuckle each of the fastening elements comprises a bore so that single screws can go through each of the fastening elements and get fixed by inner threads of the knuckle. The fasting element 20 has a stiffening element 22 spaced in the circumferential direction from the bore and projecting in the axial direction of the wheel bearing outer ring where it is fixed to the outer surface of the metal ring. The fastening element 22 has a second stiffening element on the circumferentially other side of the bore. Each of the stiffening elements increases the local stiffness of the fastening element 22. All the fastening elements are identical in their construction.

The first ring 12 is also a one-piece element. It is positioned at an axial end 24 of the wheel bearing outer ring and has a surface 26 which is on its radially inner side and which is suitable for attachment of a gasket configured for sealing a space between the wheel bearing outer ring and a wheel bearing inner ring in a fully assembled condition of the wheel bearing. The gasket can for example be press fitted to the surface 26. Moreover, the metal ring has a hole 30 extending from a radially inner surface 32 of the metal ring to a radially outer surface of the metal ring. In fact the metal ring has a series of holes spaced away from the hole 30 only in circumferential direction. All these holes are equally spaced from each other in the circumferential direction. The holes are positioned at a range 36 of the metal ring which is located axially in the middle of the wheel bearing outer ring. Some of these holes are through-holes, others are blind holes. In different embodiments of the invention the ratio of the number of through-holes to the number of blind holes can differ depending on the application. Possible are also embodiments where all the holes are through-holes or all the holes are blind holes.

At the range 36 the metal ring also comprises a groove extending in the circumferential direction of the metal ring about the whole metal ring. The groove is located at the radially outer surface of the metal ring.

Moreover, the wheel bearing outer ring comprises a second ring 40 which is also made of composite material and which is to a large extent positioned within the groove. The ring 40 is form-locked to the metal ring 14 with respect to the axial direction. At an axial position 44 at which the first ring is located the metal ring has an outer diameter 42 of 140 mm Because of this large diameter a big stiffness is implied.

The second ring 40 ensures that at the range 36 the radially outer surface of the wheel bearing outer ring has the shape of the outer surface of a circular cylinder.

The two rings 12, 40 are made of Carbon fibers and epoxy resin. But a lot of composites may be used, as for example a combination of fiber (glass, epoxy, Kevlar etc.) and thermosets or thermoplastic matrixes. The metal ring is made of G55LS steel, but many other steels could apply to the specification of the metal ring. For instance, using aeronautic grade steel leads to a lighter ring since this steel is more resistant (M50 steel for instance). The metal ring can be made of any metallic material which is adaptable to rolling contacts.

The ring 12 is fixed to the metal ring with the help of epoxy glue. At the radially inner surface of the metal ring which touches the ring 12 the metal ring comprises three circumferential shoulders which increase the axial fixation of the ring 12 to the metal ring.

The described wheel bearing outer ring saves 10% of mass in comparison to a wheel bearing outer ring which is made completely from metal and which possesses the same stiffness.

A wheel bearing which comprises the wheel bearing outer ring can be a part of a car, and in particular of a hyper car.

### REFERENCE ELEMENT LISTING

10 wheel bearing outer ring
12 ring
14 ring
16 raceway
18 raceway
20 fastening element
22 stiffening element
24 axial end
26 surface
30 hole
32 surface
36 range
38 groove
40 ring
42 diameter

1. A wheel bearing outer ring comprising:
at least a first ring made of a composite material, and
a metal ring, wherein
the metal ring comprises at least two raceways that are configured for rolling elements to roll upon.

2. The wheel bearing outer ring according to claim 1, comprising at least a first ring made of a composite material and a metal ring, wherein the metal ring comprises at least one raceway for rolling elements to roll upon and at least one fastening element configured to fix the wheel bearing outer ring to a knuckle.

3. The wheel bearing outer ring according to claim 3, comprising at least one stiffening element that increases the local stiffness of the fastening element.

4. The wheel bearing outer ring according to claim 1, comprising at least a first ring made of a composite material and a metal ring, wherein the first ring is positioned at an axial end of the wheel bearing outer ring and provides a surface for attaching a gasket configured for sealing a space between the wheel bearing outer ring and a wheel bearing inner ring in a fully assembled condition.

5. The wheel bearing outer ring according to claim 1, comprising at least a first ring made of a composite material and a metal ring, wherein the metal ring has at least one hole and/or at least one through hole and/or at least one blind hole, and wherein in the case the metal ring comprises a through hole it is extending from a radial inner surface of the metal ring to a radial outer surface of the metal ring.

6. The wheel bearing outer ring according to claim 1, wherein the metal ring comprises at a range, which is positioned axially in the middle of the wheel bearing outer ring, at least one groove at its radially outer surface.

7. The wheel bearing outer ring according to claim 6, wherein the wheel bearing outer ring comprises at least a second ring made of a composite material that is at least partially positioned within the groove.

8. The wheel bearing outer ring according to claim 1, wherein the metal ring has an outer diameter of more than 134 mm at an axial position at which the first ring is located.

9. A wheel bearing with at least one wheel bearing outer ring according to claim 1.

10. A hyper car with at least one wheel bearing according to claim 9.
